(19) United States
(12) Patent Application Publication
(10) Pub. No.: US 2005/0092040 A1
(43) Pub. Date: May 5, 2005

(54) Door lock with a coupling mechanism for simultaneous movement of latch bolt and deadbolt

(76) Inventor: Ya-Yun Chuang, Chia-Yi City (TW)

Correspondence Address: John F. Gulbin;Pitney, Hardin, Kipp & Szuch LLP, 685 Third Avenue, New York, NY, 10017-4024, US

(21) Appl. No.: 10/695,676

(22) Filed: Oct. 29, 2003

(51) Int. Cl. E05B 59/00; E05B 63/14

(52) U.S. Cl. 70/107

(57) ABSTRACT

A door lock includes a lock housing, a latch bolt and a deadbolt that are operable for movement between locking and unlocking positions, a door handle and a manually operable member, each of which has a shaft portion that is capable of driving a respective one of the latch bolt and the deadbolt between the locking and unlocking positions, and a coupler retained slidably in the lock housing. When the latch bolt and the deadbolt are in the locking positions, and the door handle is rotated to drive movement of the latch bolt to the unlocking position, the shaft portion of the door handle drives the coupler so as to displace the coupler in the lock housing such that the coupler engages the shaft portion of the manually operable member so as to rotate the manually operable member to drive movement of the deadbolt to the unlocking position.

### BACKGROUND OF THE INVENTION

1. Field of the Invention

The invention relates to a door lock, more particularly to a door lock with a coupling mechanism for simultaneous movement of a latch bolt and a deadbolt to their unlocking positions.

2. Description of the Related Art

A conventional door lock for a door panel includes a lock housing, a latch bolt, a door handle, a first deadbolt, a first manually operable member, a second deadbolt, a second manually operable member, and a coupling mechanism.

The lock housing includes a base wall that has inner and outer surfaces and a surrounding wall that extends from a periphery of the base wall and that surrounds the inner surface. The inner surface of the base wall of the lock housing has a left end portion, a right end portion opposite to the left end portion in a first direction, and an intermediate portion disposed between the left and right end portions. The latch bolt is mounted on the door panel and is operable for movement between a locking position, where the latch bolt is extended relative to the door panel, and an unlocking position, where the latch bolt is retracted relative to the door panel. The door handle is mounted rotatably on the outer surface of the base wall of the lock housing, has a shaft portion that extends through the intermediate portion of the base wall of the lock housing and that is coupled to the latch bolt, is rotatable relative to the lock housing between a first angular position, where the latch bolt is disposed at the locking position, and a second angular position, where the latch bolt is disposed at the unlocking position, and includes a first coupling ring that is sleeved co-rotatably on the shaft portion of the door handle and that is formed with a pair of radially extending left and right projections, each of which is disposed on a respective one of the left and right end portions of the inner surface of the base wall of the lock housing. The first deadbolt is mounted on the door panel and is operable for movement between a locking position, where the first deadbolt is extended relative to the door panel, and an unlocking position, where the first deadbolt is retracted relative to the door panel. The first manually operable member is mounted rotatably on the outer surface of the base wall of the lock housing, is spaced apart from the door handle in a second direction transverse to the first direction, has a shaft portion that extends through the intermediate portion of the base wall of the lock housing and that is coupled to the first deadbolt, is rotatable relative to the lock housing between a third angular position, where the first deadbolt is disposed at the locking position, and a fourth angular position, where the first deadbolt is disposed at the unlocking position, and includes a second coupling ring that is sleeved co-rotatably on the shaft portion of the first manually operable member and that is formed with a pair of radially extending left and right projections, each of which is disposed on a respective one of the left and right end portions of the inner surface of the base wall of the lock housing. The second deadbolt is mounted on the door panel and is operable for movement between a locking position, where the second deadbolt is extended relative to the door panel, and an unlocking position, where the second deadbolt is retracted relative to the door panel. The second manually operable member is mounted rotatably on the outer surface of the base wall of the lock housing, is disposed between the first manually operable member and the door handle, has a shaft portion that extends through the intermediate portion of the base wall of the lock housing and that is coupled to the second deadbolt, is rotatable relative to the lock housing between a fifth angular position, where the second deadbolt is disposed at the locking position, and a sixth angular position, where the second deadbolt is disposed at the unlocking position, and includes a third coupling ring that is sleeved co-rotatably on the shaft portion of the second manually operable member and that is formed with a pair of left and right projections that extend radially and respectively to the left and right end portions of the inner surface of the base wall of the lock housing. The coupling mechanism includes a coupler that is mounted slidably in the lock housing and that has left, intermediate and right end portions disposed respectively on the left, intermediate and right end portions of the base wall of the lock housing. Each of the left, intermediate and right end portions of the coupler has an upper section, a lower section opposite to the upper section in the second direction, and a middle section disposed between the upper and lower sections. Each of the upper, middle and lower sections of the intermediate portion of the coupler is formed with a slide slot that extends in the second direction. Each of the shaft portions of the door handle and the first and second manually operable members extends through a respective one of the slide slots in the intermediate portion of the coupler. A retainer is fitted on the shaft portion of the door handle. The construction as such permits retention of the coupler on the shaft portion of the door handle while permitting the coupler to move upwardly and downwardly in the lock housing. The upper section of each of the left and right end portions of the coupler is formed with a first projection. The middle section of each of the left and right end portions of the coupler is formed with a second projection. The lower section of each of the left and right end portions of the coupler is formed with a third projection. The coupling mechanism further includes a pair of restoring springs. Each of the left and right end portions of the inner surface of the base wall of the lock housing is formed with a first spring engaging member. Each of the left and right end portions of the coupler is formed with a second spring engaging member. Each of the restoring springs has one end that is hooked on the first spring engaging member of a respective one of the left and right end portions of the inner surface of the base wall of the lock housing, and an opposite end that is hooked on the second spring engaging member of a respective one of the left and right end portions of the coupler. The construction as such permits the restoring springs to provide a restoring force to restore the door handle from the second angular position to the first angular position.

In operation, with the conventional door lock mounted on a right side of the door panel, when the first and second manually operable members are in the third and fifth angular positions, respectively, and the door handle is rotated from the first angular position to the second angular position, the left projection of the first coupling ring on the shaft portion of the door handle engages the third projection on the lower section of the left end portion of the coupler and drives the coupler so as to displace the coupler in the lock housing such that the first and second projections on each of the upper and middle sections of the left end portion of the coupler engages the left projection on a respective one of the second and third coupling rings so as to rotate the first and second manually operable members to the fourth and sixth angular positions, respectively.

Although the conventional door lock achieves the purpose of simultaneously moving each of the latch bolt, and the first and second deadbolts to their unlocking positions, since the coupler needs to be formed with the slide slots, and since each of the slide slots have to aligned with the shaft portion of each of the door handle and the first and second manually operable members during assembly, the manufacturing process thereof is relatively complicated, thereby resulting in poor productivity and higher costs.

### SUMMARY OF THE INVENTION

Therefore, the object of the present invention is to provide a door lock that has a relatively simple construction and that is provided with a coupling mechanism for moving simultaneously a latch bolt and a deadbolt.

According to the present invention, a door lock for a door panel comprises a lock housing, a latch bolt, a door handle, a deadbolt, and a manually operable member. The lock housing is adapted to be mounted on the door panel, has an inner surface with a left end portion, a right end portion opposite to the left end portion in a first direction, and an intermediate portion disposed between the left and right end portions. The latch bolt is adapted to be mounted on the door panel, and is operable for movement between a locking position, where the latch bolt is extended relative to the door panel, and an unlocking position, where the latch bolt is retracted relative to the door panel. The door handle is mounted rotatably on the lock housing, and has a shaft portion that extends through the intermediate portion of the lock housing and that is coupled to the latch bolt. The door handle is rotatable relative to the lock housing between a first angular position, where the latch bolt is disposed at the locking position, and a second angular position, where the latch bolt is disposed at the unlocking position. The deadbolt is adapted to be mounted on the door panel, and is operable for movement between a locking position, where the deadbolt is extended relative to the door panel, and an unlocking position, where the deadbolt is retracted relative to the door panel. The manually operable member is mounted rotatably on the lock housing, is spaced apart from the door handle in a second direction transverse to the first direction, and has a shaft portion that extends through the intermediate portion of the lock housing, that is coupled to the deadbolt, and that is provided with a first projection. The manually operable member is rotatable relative to the lock housing between a third angular position, where the deadbolt is disposed at the locking position, and a fourth angular position, where the deadbolt is disposed at the unlocking position. The coupling mechanism includes a coupler retained slidably on the left or right end portion of the lock housing. The coupler has an upper end portion formed with a protrusion, a lower end portion opposite to the upper end portion in the second direction and coupled to the shaft portion of the door handle, and a middle portion disposed between the upper and lower end portions and formed with a slide slot that extends in the second direction. The coupling mechanism further includes a retainer that passes through the slide slot and that engages the left or right end portion of the lock housing to retain the coupler on the lock housing. When the manually operable member is in the third angular position, and the door handle is rotated from the first angular position to the second angular position, the shaft portion of the door handle drives the lower end portion of the coupler so as to displace the coupler in the lock housing such that the protrusion on the upper end portion of the coupler engages the projection on the shaft portion of the manually operable member so as to rotate the manually operable member to the fourth angular position.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of the preferred embodiment of a door lock according to the present invention;

FIG. 2 is a schematic view of the preferred embodiment to illustrate a latch bolt in a locked position, and first and second deadbolts in unlocked positions;

FIG. 3 is a schematic view of the preferred embodiment to illustrate the latch bolt and first and second deadbolts in the locked positions; and

FIG. 4 is a schematic view of the preferred embodiment to illustrate the latch bolt and first and second deadbolts in the unlocked positions.

### DETAILED DESCRIPTION OF THE PREFERRED EMBODIMENT

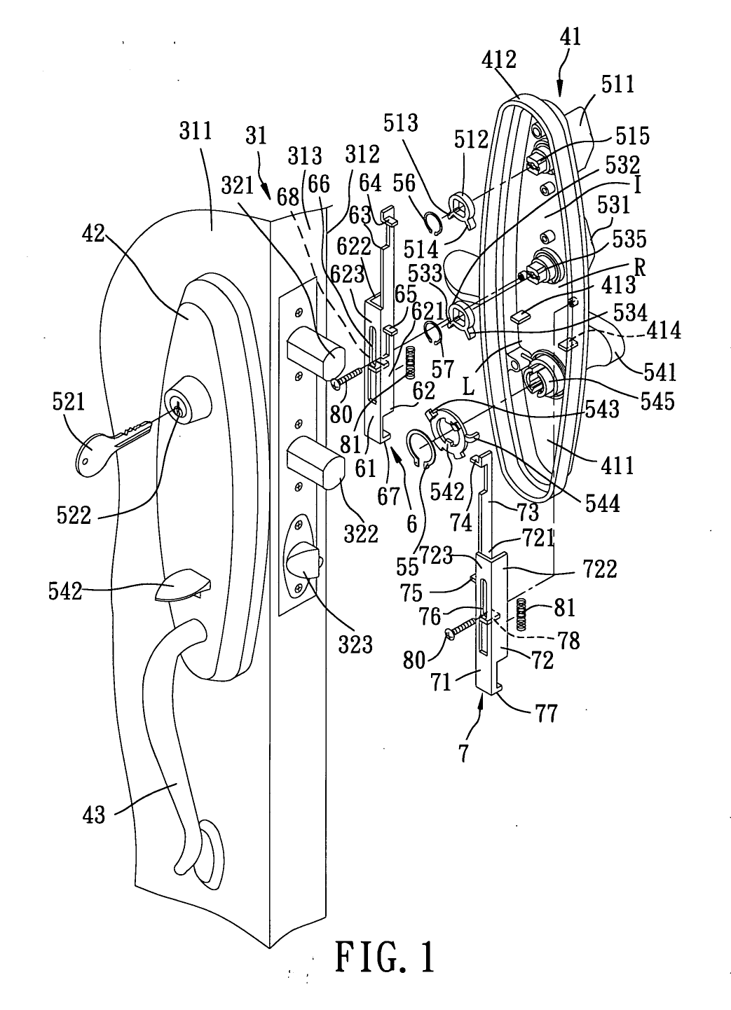

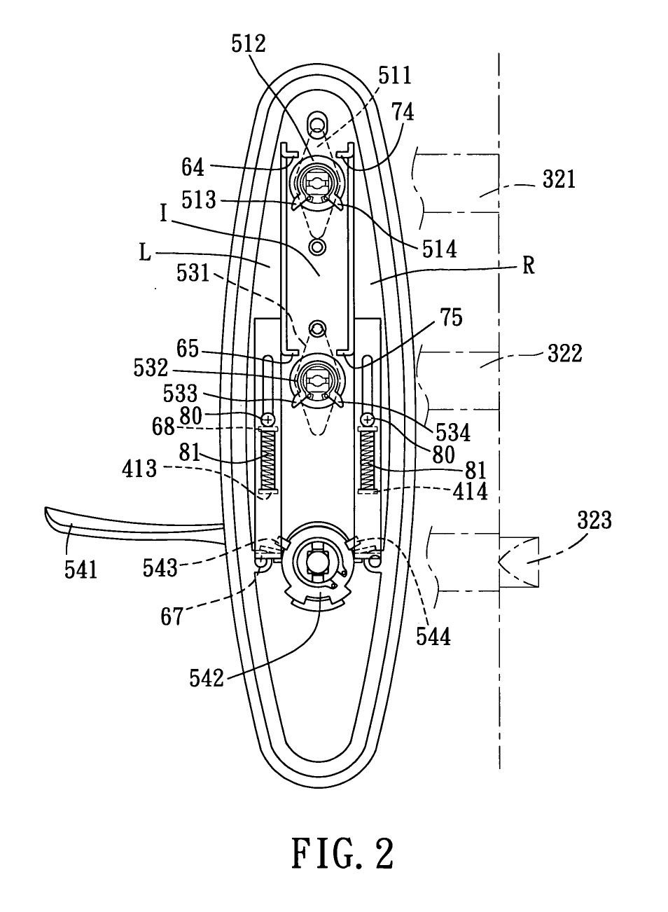

Referring to FIGS. 1 and 2, the preferred embodiment of a door lock for a door panel 31 according to this invention is shown to include an inner lock housing 41, a latch bolt 323, a door handle 541, a first deadbolt 321, a first manually operable member 511, and a coupling mechanism.

The door panel 31 has an inner wall surface 312, an outer wall surface 311, and a peripheral surface 313 that interconnects the inner and outer wall surfaces 312, 311.

The inner lock housing 41 is adapted to be mounted on the inner wall surface 312 of the door panel 31, and includes a base wall 411 that has inner and outer surfaces and a surrounding wall 412 that extends from a periphery of the base wall 411 and that surrounds the inner surface of the base wall 411. The inner surface of the base wall 411 of the inner lock housing 41 has a left end portion (L), a right end portion (R) opposite to the left end portion (L) in a first direction, and an intermediate portion (I) disposed between the left and right end portions (L, R).

The latch bolt 323 is adapted to be mounted on the door panel 31 and is operable for movement between a locking position, where the latch bolt 323 is extended relative to the peripheral surface 313 of the door panel 31, and an unlocking position, where the latch bolt 323 is retracted relative to the peripheral surface 313 of the door panel 31.

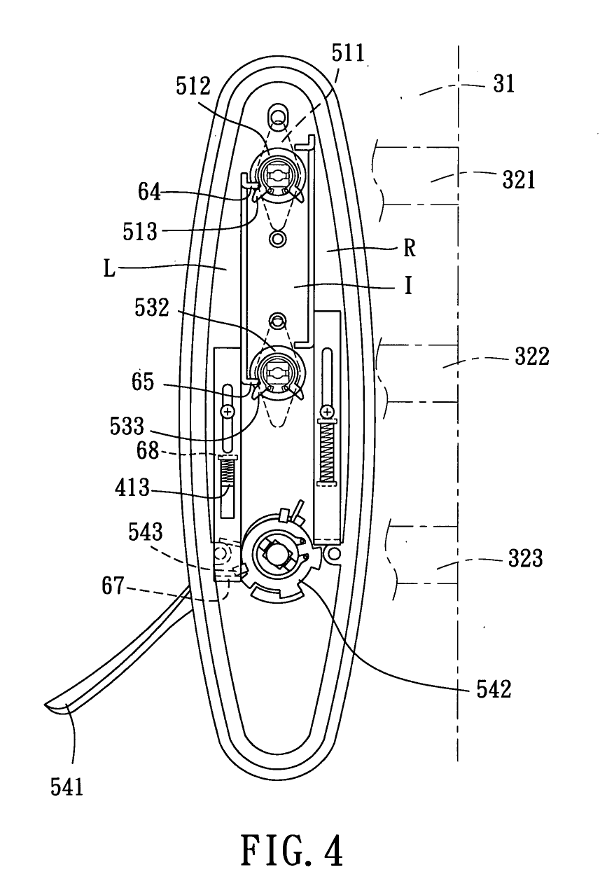

The door handle 541 is mounted rotatably on the outer surface of the base wall 411 of the inner lock housing 41, and has a shaft portion 545 that extends through the intermediate portion (I) of the base wall 411 of the inner lock housing 41 and that is coupled to the latch bolt 323. The door handle 541 is rotatable relative to the inner lock housing 41 between a first angular position, where the latch bolt 323 is disposed at the locking position (see FIG. 2), and a second angular position, where the latch bolt 323 is disposed at the unlocking position (see FIG. 4). Since the feature of the present invention does not reside in the specific configurations of the shaft portion 545 of the door handle 541 and the latch bolt 323, which are conventional in construction, a detailed description of the same is omitted herein for the sake of brevity.

The door handle 541 further has a first coupling ring 542 and a first snap ring 55. The first coupling ring 542 is sleeved co-rotatably on the shaft portion 545 of the door handle 541, and is formed with a pair of left and right projections 543, 544, each of which extends radially from the first coupling ring 54 and is disposed on a respective one of the left and right end portions (L, R) of the inner surface of the base wall 411 of the inner lock housing 41. The first snap ring 55 is fitted on the shaft portion 545 of the door handle 541 so as to retain the first coupling ring 542 on the shaft portion 545 of the door handle 541.

The first deadbolt 321 is adapted to be mounted on the door panel 31 and is operable for movement between a locking position, where the first deadbolt 321 is extended relative to the peripheral surface 313 of the door panel 31, and an unlocking position, where the first deadbolt 321 is retracted relative to the peripheral surface 313 of the door panel 31.

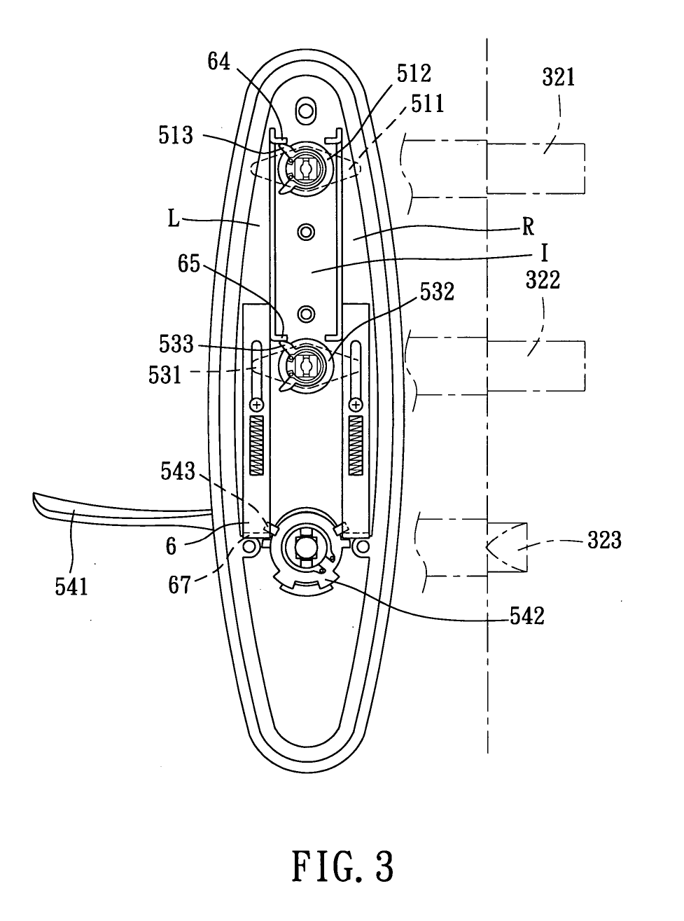

The first manually operable member 511 is mounted rotatably on the outer surface of the base wall 411 of the inner lock housing 41, is spaced apart from the door handle 541 in a second direction transverse to the first direction, and has a shaft portion 515 that extends through the intermediate portion (I) of the base wall 411 of the inner lock housing 41 and that is coupled to the first deadbolt 321. The first manually operable member 511 is rotatable relative to the inner lock housing 41 between a third angular position, where the first deadbolt 321 is disposed at the locking position (see FIG. 3), and a fourth angular position, where the first deadbolt 321 is disposed at the unlocking position (see FIG. 4). Since the feature of the present invention does not reside in the specific configurations of the shaft portion 515 of the first manually operable member 511 and the first deadbolt 321, which are conventional in construction, a detailed description of the same is omitted herein for the sake of brevity.

The first manually operable member 511 further has a second coupling ring 512 and a second snap ring 56. The second coupling ring 512 is sleeved co-rotatably on the shaft portion 515 of the first manually operable member 511, and is formed with a pair of left and right projections 513, 514, each of which extends radially from the second coupling ring 512 and is disposed on a respective one of the left and right end portions (L, R) of the inner surface of the base wall 411 of the inner lock housing 41. The second snap ring 56 is fitted on the shaft portion 515 of the first manually member 511 so as to retain the second coupling ring 512 on the shaft portion 515 of the first manually operable member 511.

An outer lock housing 42 is mounted on the outer wall surface 311 of the door panel 31, and has an upper end portion, a lower end portion opposite to the upper end portion in the second direction, and an intermediate portion disposed between the upper and lower end portions. A handle 43 has a top end mounted on the lower end portion of the outer lock housing 42, and a bottom end secured to the door panel 31. A key-operated lock unit 522 is mounted on the upper end portion of the outer lock housing 42. By operating the key-operated lock unit 522 with a corresponding key 521, the first deadbolt 321 can be moved between the locking and unlocking positions. In addition, a lever 542 is mounted on the intermediate portion of the outer lock housing 42 adjacent to the top end of the handle 43. By pressing the lever 542, the latch bolt 323 can be moved between the locking and unlocking positions. It is noted, however, that pressing the lever 542 does not result in rotation of the door handle 541. Since the feature of the present invention does not reside in the particular configurations of the key-operated lock unit 522 and the lever 542, which are conventional in construction, a detailed description of the same is omitted herein for the sake of brevity.

The coupling mechanism includes first and second couplers 6, 7, each of which is disposed on a respective one of the left and right end portions (L, R) of the inner surface of the base wall 411 of the inner lock housing 41, and has an upper end portion 63, 73, a lower end portion 61, 71 opposite to the upper end portion 63, 73 in the second direction, and a middle portion 62, 72 disposed between the upper and lower end portions 63, 73, 61, 71. The upper end portion 63, 73 of each of the first and second couplers 6, 7 is formed with first and second upper protrusions 64, 74, 65, 75 that are spaced apart from each other in the second direction and that extend toward the intermediate portion (I) of the inner surface of the base wall 411 of the inner lock housing 41. The lower end portion 61, 71 of each of the first and second couplers 6, 7 is formed with a lower protrusion 67, 77 that extends toward the respective one of the left and right end portions (L, R) of the inner surface of the base wall 411 of the inner lock housing 41. The middle portion 62, 72 of each of the first and second couplers 6, 7 is formed with a slide slot 66, 76 that extends in the second direction, and a first abutting member 68, 78 that extends toward the respective one of the left and right end portions (L, R) of the inner surface of the base wall 411 of the inner lock housing 41. In particular, the middle portion 62, 72 of each of the first and second couplers 6, 7 has a U-shaped cross-section, confines a spring-accommodating space that opens toward the respective one of the left and right end portions (L, R) of the inner surface of the base wall 411 of the inner lock housing 41, and is defined by first and second walls 621, 622, 721, 722 and a third wall 623, 723 that interconnects the first and second walls 621, 622, 721, 722 and that has first and second sections opposite to each other in the second direction. The upper end portion 63, 73 of each of the first and second couplers 6, 7 extends from the first wall 621, 721. The lower end portion 61, 71 of each of the first and second couplers 6, 7 extends from the third wall 623, 723. Each slide slot 66, 76 is formed in the first section of the third wall 623, 723 of the middle portion 62, 72 of the respective one of the first and second couplers 6, 7. Each first abutting member 68, 78 is formed in the second section of the third wall 623, 723 of the middle portion 62, 72 of the respective one of the first and second couplers 6, 7.

The coupling mechanism further includes a pair of retainers 80 and a pair of restoring springs 81. Each of the left and right end portions (L, R) of the inner surface of the base wall 411 of the inner lock housing 41 is formed with a threaded hole. Each of the retainers 80 passes through the slide slot 66, 76 in the first section of the third wall 623, 723 of the middle portion 62, 72 of a respective one of the first and second couplers 6, 7 and is threaded into the threaded hole in a respective one of the left and right end portions (L, R) of the inner surface of the base wall 411 of the inner lock housing 41. The construction as such permits the first and second couplers 6, 7 to be retained and to be slidable in the second direction on the inner lock housing 41.

Each of the left and right end portions (L, R) of the inner surface of the base wall 411 of the inner lock housing 41 is formed with a second abutting member 413, 414 that extends away from the inner surface of the base wall 411 of the inner lock housing 41. Each of the restoring springs 81 is disposed in the spring-accommodating space of the middle portion 62, 72 of a respective one of the first and second couplers 6, 7, and has a first end abutting against the first abutting member 68, 78 of the second section of the third wall 623, 723 of the middle portion 62, 72 of the respective one of the first and second couplers 6, 7, and a second end opposite to the first end and abutting against the second abutting member 413, 414 on a respective one of the left and right end portions (L, R) of the inner surface of the base wall 411 of the inner lock housing 41. The construction as such permits the restoring springs 81 to provide a restoring force to restore the door handle 541 from the second angular position to the first angular position.

The door lock further includes a second deadbolt 322 and a second manually operable member 531. The second deadbolt 322 is adapted to be mounted on the door panel 31 and is operable for movement between a locking position, where the second deadbolt 322 is extended relative to the peripheral surface 313 of the door panel 31, and an unlocking position, where the second deadbolt 322 is retracted relative to the peripheral surface 313 of the door panel 31.

The second manually operable member 531 is mounted rotatably on the outer surface of the base wall 411 of the inner lock housing 41, is disposed between the first manually operable member 511 and the door handle 541, and has a shaft portion 535 that extends through the intermediate portion (I) of the base wall 411 of the inner lock housing 41 and that is coupled to the second deadbolt 322. The second manually operable member 531 is rotatable relative to the inner lock housing 41 between a fifth angular position (see FIG. 3), where the second deadbolt 322 is disposed at the locking position, and a sixth angular position, where the second deadbolt 322 is disposed at the unlocking position (see FIG. 4). Since the feature of the present invention does not reside in the specific configurations of the shaft portion 535 of the second manually member 531 and the second deadbolt 322, which are conventional in construction, a detailed description of the same is omitted herein for the sake of brevity.

The second manually operable member 531 further has a third coupling ring 532 and a third snap ring 57. The third coupling ring 532 is sleeved co-rotatably on the shaft portion 535 of the second manually operable member 531, and is formed with a pair of left and right projections 533, 534, each of which extends radially from the third coupling ring 532 and is disposed on the respective one of the left and right end portions (L, R) of the inner surface of the base wall 411 of the inner lock housing 41. The third snap ring 57 is fitted on the shaft portion 535 of the second manually member 531 so as to retain the third coupling ring 532 on the shaft portion 535 of the second manually operable member 531.

It is noted that the second deadbolt 322, unlike the latch bolt 323 and the first deadbolt 321, can only be moved between the locking and unlocking positions from the inside of a room (not shown). In other words, there is no access from the outside of the room that can cause movement of the second deadbolt 322 between the locking and unlocking positions.

In operation, with the door lock mounted on a right side of the door panel 31, starting from the state illustrated in FIG. 2, initially, the first and second manually operable members 511, 531 and the door handle 541 are at the fourth, sixth and first angular positions, respectively. At this time, with further reference to FIG. 3, when it is desired to move the first and second deadbolts 321, 322 to their locking positions, the first and second manually operable members 511, 531 are rotated to the third and fifth angular positions, respectively. At this time, with further reference to FIG. 4, when it is desired to simultaneously move the latch bolt 323 and the first and second deadbolts 321, 322 to their unlocking positions, a rotating force is applied to rotate the door handle 541 to the second angular position against biasing action of one of the restoring springs 81. The rotation of the door handle 541 causes the left projection 543 of the first coupling ring 542 on the shaft portion 545 of the door handle 541 to engage the lower protrusion 67 at the lower end portion 61 of the first coupler 6. This permits the shaft portion 545 of the door handle 541 to drive the lower end portion 61 of the first coupler 6 so as to displace the first coupler 6 in the inner lock housing 41. The displacement of the first coupler 6 causes the first and second upper protrusions 64, 65 of the upper end portion 63 of the first coupler 6 to engage respectively the left projection 513 of the second coupling ring 512 on the shaft portion 515 of the first manually operable member 511 and the left projection 533 of the third coupling ring 532 on the shaft portion 535 of the second manually operable member 531, respectively. Accordingly, the first and second manually operable members 511, 531 are rotated respectively back to the fourth and sixth angular positions. When the door handle 541 is released from the rotating force, the door handle 541 rotates back to the first angular position due to the restoring force of the restoring spring 81, the first coupler 6 moves back to its initial position, and the latch bolt 323 moves back to the locking position, as best shown in FIG. 2.

It is noted that the door lock of this invention is also suitable for mounting on a left side of the door panel 31. Since the operation of the door lock mounted on the left side of the door panel 31 is analogous to that described hereinabove in connection with the door lock mounted on the right side of the door panel 31, a detailed description of the same will be dispensed with herein for the sake of brevity.

During assembly, the door handle 541, and the first and second manually operable members 511, 531 are mounted on the inner lock housing 41 such that the shaft portion 545, 535, 515 of each of the door handle 541 and the first and second manually operable members 511, 531 extends through the intermediate portion (I) of the base wall 411 of the inner lock housing 41. Subsequently, each of the first, second and third coupling rings 542, 512, 532 is sleeved on the shaft portion 545, 535, 515 of the respective one of the door handle 541 and the first and second manually operable members 511, 531. Afterwards, each of the first, second and third snap rings 55, 56, 57 is fitted on the shaft portion 545, 535, 515 of the respective one of the door handle 541 and the first and second manually operable members 511, 531. Each of the restoring springs 81 is then placed in the spring-accommodating space of the middle portion 62, 72 of the respective one of the first and second couplers 6, 7, with the first end of each restoring spring 81 abutting against the first abutting member 68, 78 on the second section of the third wall 623, 723 of the middle portion 62, 72 of the respective one of the first and second couplers 6, 7. The first and second couplers 6, 7 are then brought respectively toward the left and right end portions (L, R) of the inner surface of the base wall 411 of the inner lock housing 41 such that each of the second abutting members 413, 414 is received in the spring-accommodating space of the respective one of the first and second couplers 6, 7, and such that the second end of each restoring spring 81 abuts against the second abutting member 413, 414 on the respective one of the left and right end portions (L, R) of the inner surface of the base wall 411 of the inner lock housing 41. Finally, each of the retainers 80 is inserted through the slide slot 66, 76 in the respective one of the first and second couplers 6, 7 and is threaded into a respective one of the threaded holes in the respective one of the left and right end portions (L, R) of the inner surface of the base wall 411 of the inner lock housing 41.

It is noted that one of the first and second couplers 6, 7 may be dispensed with once the mounting position, either on the left or right side of the door panel 31, of the door lock is determined. Accordingly, one of the restoring springs 81, and one of the left and right projections 543, 544, 513, 514, 533, 534 on each of the first, second and third coupling rings 542, 512, 532 may be similarly dispensed with.

It has thus been shown that the door lock of this invention includes: a latch bolt 323 and first and second deadbolts 321, 322, each of which is operable for movement between locking and unlocking positions; a door handle 541 and first and second manually operable members 511, 531, each of which has a shaft portion 545, 515, 535 that is capable of driving a respective one of the latch bolt 323 and the first and second deadbolts 321, 322 between the locking and unlocking positions; and a coupling mechanism including a coupler 6, 7 driven by the shaft portion 545 of the door handle 541 so as to displace the coupler 6, 7, whereby displacement of the coupler 6, 7, when the first and second deadbolts 321, 322 are at the locking positions, results in the engagement of the coupler 6, 7 and the shaft portions 515, 535 of the first and second manually members 511, 535 so as to rotate the first and second manually operable members 511, 535, thereby driving movement of the first and second deadbolts 321, 322 to the unlocking positions. The construction as such permits simultaneous movement of the latch bolt 323 and the first and second deadbolts 321, 322 to their unlocking positions.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A door lock for a door panel, said door lock comprising:
a lock housing adapted to be mounted on the door panel, having an inner surface with a left end portion, a right end portion opposite to said left end portion in a first direction, and an intermediate portion disposed between said left and right end portions;
a latch bolt adapted to be mounted on the door panel and operable for movement between a locking position, where said latch bolt is extended relative to the door panel, and an unlocking position, where said latch bolt is retracted relative to the door panel;
a door handle mounted rotatably on said lock housing and having a shaft portion that extends through said intermediate portion of said lock housing and that is coupled to said latch bolt, said door handle being rotatable relative to said lock housing between a first angular position, where said latch bolt is disposed at the locking position, and a second angular position, where said latch bolt is disposed at the unlocking position;
a first deadbolt adapted to be mounted on the door panel and operable for movement between a locking position, where said first deadbolt is extended relative to the door panel, and an unlocking position, where said first deadbolt is retracted relative to the door panel;
a first manually operable member mounted rotatably on said lock housing, spaced apart from said door handle in a second direction transverse to said first direction, and having a shaft portion that extends through said intermediate portion of said lock housing, that is coupled to said first deadbolt, and that is provided with a first projection, said first manually operable member being rotatable relative to said lock housing between a third angular position, where said first deadbolt is disposed at the locking position, and a fourth angular position, where said first deadbolt is disposed at the unlocking position; and
a coupling mechanism including a coupler retained slidably on one of said left and right end portions of said lock housing, said coupler having an upper end portion formed with a first protrusion, a lower end portion opposite to said upper end portion in the second direction and coupled to said shaft portion of said door handle, and a middle portion disposed between said upper and lower end portions and formed with a slide slot that extends in the second direction, said coupling mechanism further including a retainer that passes through said slide slot and that engages said one of said left and right end portions of said lock housing to retain said coupler on said lock housing,
wherein, when said first manually operable member is in the third angular position, and said door handle is rotated from the first angular position to the second angular position, said shaft portion of said door handle drives said lower end portion of said coupler so as to displace said coupler in said lock housing such that said first protrusion on said upper end portion of said coupler engages said first projection on said shaft portion of said first manually operable member so as to rotate said first manually operable member to the fourth angular position.

2. The door lock as claimed in claim 1, further comprising:
a second deadbolt adapted to be mounted on the door panel and operable for movement between a locking position, where said second deadbolt is extended relative to the door panel, and an unlocking position, where said second deadbolt is retracted relative to the door panel; and
a second manually operable member mounted rotatably on said lock housing, disposed between said first manually operable member and said door handle, and having a shaft portion that extends through said intermediate portion of said lock housing and that is coupled to said second deadbolt, said second manually operable member being rotatable relative to said lock housing between a fifth angular position, where said second deadbolt is disposed at the locking position, and a sixth angular position, where said second deadbolt is disposed at the unlocking position.

3. The door lock as claimed in claim 2, wherein said shaft portion of said second manually operable member is provided with a second projection, said upper end portion of said coupler being further formed with a second protrusion that is spaced apart from said first protrusion in the second direction,
wherein, when said second manually operable member is in the fifth angular position, and said door handle is rotated from the first angular position to the second angular position, said second protrusion on said upper end portion of said coupler engages said second projection on said shaft portion of said second manually operable member so as to move said second manually operable member to the sixth position.

4. The door lock as claimed in claim 1, wherein said coupling mechanism further includes a restoring spring having one end that abuts against said coupler and an opposite end that abuts against said lock housing for providing a restoring force to restore said door handle from the second angular position to the first angular position.

5. The door lock as claimed in claim 1, wherein said middle portion of said coupler has a U-shaped cross-section, confines a spring-accommodating space that opens toward the respective one of said left and right end portions of said inner surface of said lock housing, and is defined by first and second walls and a third wall that interconnects said first and second walls, said upper end portion of said coupler extending from said first wall, said lower end portion of said coupler extending from said third wall, said slide slot being formed in said third wall.

6. The door lock as claimed in claim 5, wherein said coupling mechanism further includes a restoring spring disposed in said spring-accommodating space and having one end that abuts against said coupler an opposite end that abuts against said lock housing.
